(19) United States
(12) Patent Application Publication
(10) Pub. No.: US 2006/0065644 A1
(43) Pub. Date: Mar. 30, 2006

(54) Semiconductor device, method of measuring light intensity distribution of laser light, laser annealing apparatus, and crystallization method

(76) Inventors: Masayuki Jyumonji, Yokohama-shi (JP); Masato Hiramatsu, Yokohama-shi (JP); Masakiyo Matsumura, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/099,563

(22) Filed: Apr. 6, 2005

(30) Foreign Application Priority Data
Sep. 27, 2004 (JP) 2004-280708

(51) Int. Cl. B23K 26/00

(52) U.S. Cl. 219/121.65

(57) ABSTRACT

An amorphous silicon layer is deposited on a glass substrate via an underlayer insulating film, and further a light-emitting layer is inserted between the glass substrate and the underlayer insulating film in a partial region on the glass substrate. To measure light intensity distribution of laser light applied to the amorphous silicon layer, the laser light is applied to the light-emitting layer from the surface of a substrate to be treated. The light intensity distribution of the light emitted from the light-emitting layer is two-dimensionally imaged using an optical image pickup system from the back surface of the substrate to be treated, and measured using an image pickup device. The light intensity distribution of the laser light in the face to be treated is obtained from the light intensity distribution of the emission measured in this manner.

### CROSS-REFERENCE TO RELATED APPLICATIONS

This application is based upon and claims the benefit of priority from prior Japanese Patent Application No. 2004-280708, filed Sep. 27, 2004, the entire contents of which are incorporated herein by reference.

### BACKGROUND OF THE INVENTION

1. Field of the Invention

The present invention relates to a method of measuring an intensity distribution of laser light applied to a semiconductor device, and a semiconductor device to which this method is applied. The method of the present invention is suitable especially for measurement of the intensity distribution of ultraviolet laser light for use in laser-annealing a semiconductor thin film. Furthermore, the present invention relates to a laser annealing apparatus in which an image pickup device for measuring a laser light intensity distribution using the above-described method is incorporated, and a crystallization method in which the above-described method is used.

2. Description of the Related Art

In display devices such as an active matrix type liquid crystal device and an organic EL display device, a large number of thin film transistors (hereinafter abbreviated as TFT) are formed on an insulating substrate of glass, plastic or the like in order to individually drive each pixel. As to an amorphous silicon (a-Si) film for use in a source, drain, or channel region of the TFT, a forming temperature is low, the film can be comparatively easily formed by a vapor phase process, mass productivity is also superior, and therefore the film has been broadly used as a semiconductor thin film for forming the TFT.

However, the amorphous silicon film has a disadvantage that the film is inferior to a polycrystalline silicon (poly-Si) film in physical properties such as conductivity. (mobility of a-Si is lower than that of poly-Si by two or more digits). From now on, a method of forming the source, drain, or channel region of the TFT in the polycrystalline silicon film needs to be established in order to increase an operation speed of the TFT.

Under present conditions, for example, an annealing method using excimer laser (excimer laser annealing: hereinafter referred to as an ELA method) is used as a method of forming the polycrystalline silicon film. This annealing method can be performed in a temperature range (i.e., from room temperature to about 500° C.) in which a general-purpose glass substrate is usable.

In the ELA method, for example, after depositing an amorphous silicon film in a predetermined thickness (e.g., about 50 nm) on a substrate, krypton fluorine (KrF) excimer laser light (wavelength of 248 nm), xenon chlorine (XeCl) excimer laser light (wavelength of 308 nm) or the like is applied to the amorphous silicon film. The amorphous silicon film is locally molten, recrystallized, and changed to the polycrystalline silicon film.

The excimer laser annealing is applicable to various processes other than an annealing process, when an average intensity (fluence) of the laser light is changed. For example, when the intensity of the laser light is set to a range having an only heating function, the annealing is usable in an impurity activation step required for preparing the TFT. When the intensity of the laser light is excessively increased, a rapid temperature rise is caused, and therefore the annealing is usable for removing the film from the TFT. It is to be noted that the use of the phenomena is not limited to the TFT, and the phenomena are broadly applicable to a semiconductor process.

Additionally, in a case where the TFT is formed of a polycrystalline silicon film in order to increase the operation speed in display devices such as a liquid crystal display device and an organic EL display device, fluctuation of a threshold voltage Vth of the TFT is remarkably increased in a crystal grain boundary of the polycrystalline silicon film, and an operation characteristic of the whole display device is largely lowered. Therefore, there has been a demand for a TFT in which the crystal grain boundary is homogenized as much as possible in each channel region, or a crystal grain diameter is increased, and a position of the boundary is controlled to thereby remove the crystal grain boundary from each channel region.

The present inventors have researched/developed a technique in which a “phase shifter” for modulating phase of laser light is inserted midway in an optical path irradiated with the laser light, and accordingly the light intensity distribution (plane image) of the laser light on the amorphous silicon film is adjusted into a shape appropriate for enlargement of the diameter of the crystal grain. As a result, a manufacturing technique capable of controlling the position to form a silicon single crystal having a large grain diameter of about 2 to 7 microns has been developed.

Furthermore, it has been found that as a result of the development, the light intensity distribution (plane image) of the laser light applied to the amorphous silicon film in a micro region having a submicron level is remarkably important in order to stably obtain a crystallized region having a desired large grain diameter with controlled positioning. However, a method of correctly imaging the light intensity distribution (plane image) is very difficult, and has not been established yet in the present conditions. This is because the light intensity distribution (plane image) of the laser light in the micro region having a sub-micron level is imaged, the excimer laser light is invisible light of an ultraviolet region, and further the light is pulse laser light.

Several methods have heretofore been proposed in order to evaluate the light intensity distribution (plane image) of the laser light for use in the ELA process. According to one of the methods, the laser light is applied to the amorphous silicon film, and the light intensity distribution of the laser light is evaluated based on changes of physical properties of the silicon film. That is, the laser light is applied to the amorphous silicon film which is a process target with a light intensity (fluence) having such a threshold value that the crystallization is induced. Then, a portion having a high light intensity forms polycrystalline silicon, and the physical properties partially change. Therefore, after applying the laser light to the amorphous silicon film, a tissue of the corresponding portion is observed by a microscope, so that the laser light intensity distribution (plane image) can be estimated. It is to be noted that in the evaluation method based on the changes of the physical properties, not only the crystallization of the amorphous silicon film but also the changes of physical or chemical properties of another material (e.g., photoresist) can be utilized.

The method of imaging the light intensity distribution (plane image) of the laser light based on the changes of the physical properties has had the following problem. That is, since a relation between the light intensity and the physical property change depends largely on the threshold value of the physical property change, the laser light intensity to be applied is changed in a stepwise manner, and the physical properties have to be evaluated, and a plurality of times of laser irradiation and physical property evaluation are required. As a result, fluctuations of conditions for each laser irradiation influence results of the evaluation. There are fluctuations in the material itself that causes the physical property changes, it is therefore very difficult to grasp the light intensity distribution as the “plane image”, and the evaluation cannot be said to be correct. Furthermore, since the changes of the physical properties are evaluated by offline inspection, much time is required until the results are obtained.

Furthermore, even in a method of observing the tissue of the amorphous silicon film irradiated with the laser light with the microscope, the tissue cannot be observed in-situ, and it is difficult to introduce the method into a manufacturing line.

### BRIEF SUMMARY OF THE INVENTION

The present invention has been developed in view of the above-described problems concerning a conventional method of measuring light intensity distribution of laser light. An object of the present invention is to provide a semiconductor device capable of measuring the light intensity distribution of the laser light correctly in a short time, a method of measuring light intensity distribution of laser light, a laser annealing apparatus, and a crystallization method.

A semiconductor device of the present invention comprises: a visible light transmitting substrate; a non-single crystal semiconductor thin film formed on the substrate; and a light-emitting layer or a light-emitting region which is disposed on or in the substrate and which receives laser light to emit visible light.

The light-emitting layer or the light-emitting region is preferably disposed in at least one layer excluding the non-single crystal semiconductor thin film among a plurality of thin film layers formed on the substrate.

The light-emitting layer or the light-emitting region preferably has a thickness of 1 μm or less. The light-emitting layer or the light-emitting region further preferably has a thickness of 0.5 μm or less.

Preferably, of the visible light emitted from the light-emitting layer or the light-emitting region, the highest peak in light intensity distribution with respect to wavelength exhibits a half-value breadth of 0.05 μm or less.

It is to be noted that examples of a light-emitting material include a thin film of SiO₂ doped with Tb or Eu, and nano-particles of CdSe having a diameter of several tens of nanometers. Moreover, SiOx having a light-emitting property may be used. When a water-soluble light-emitting material is applied to a substrate surface, an organic light-emitting material such as pyranine may be used.

A method of measuring light intensity distribution of laser light according to the present invention is a method of measuring light intensity distribution in a plane of a non-single crystal semiconductor thin film formed on a visible light transmitting substrate, the method comprising:

disposing a light-emitting layer or a light-emitting region which receives laser light to emit visible light on or in the substrate;

applying the laser light toward the light-emitting layer or the light-emitting region;

imaging the light intensity distribution of the visible light emitted from the light-emitting layer or the light-emitting region from the back surface of the substrate using an optical image pickup system; and

obtaining the light intensity distribution of the laser light in the plane from the light intensity distribution of the visible light obtained in this manner.

When this method is used, the light intensity distribution of the laser light in the non-single crystal semiconductor thin film surface formed on the substrate can be measured. According to the method, since the light intensity distribution of the laser light is measured using the substrate itself to be actually treated using the laser light, a height of the face to be actually treated (i.e., the non-single crystal semiconductor thin film) can be substantially matched with that of a measurement face (i.e., light-emitting layer) for use in measuring the light intensity distribution. Therefore, the light intensity distribution in the height of the face to be actually treated can be correctly measured.

Moreover, since the light intensity distribution of the laser light is measured using the substrate itself to be actually treated using the laser light, an operation for switching an actual process (e.g., laser-annealing) using the laser light and measurement of the light intensity distribution of the laser light can be performed in a short time only by movement of the optical image pickup system and light intensity distribution measurement device.

It is to be noted that the intensity of the light emitted from the light-emitting layer is saturated, when the intensity of the applied light reaches a certain limit or more. Therefore, to measure the light intensity distribution of the laser light, the intensity of the laser light needs to be suppressed to the above-described limit or less. Therefore, to image the light intensity distribution of the laser light, the intensity of the laser light needs to be set to be lower than that of the laser light during the actual laser-annealing.

A laser annealing apparatus using the above-described method of measuring the light intensity distribution according to the present invention is a laser annealing apparatus which applies laser light to a substrate to be treated having a non-single crystal semiconductor thin film and which grows crystal grains from the non-single crystal semiconductor thin film, the substrate to be treated having a light-emitting layer or a light-emitting region which receives the laser light to emit visible light, the laser annealing apparatus comprising:

a laser light source which emits the laser light toward the substrate to be treated;

an optical image pickup system disposed on the back surface of the substrate to be treated; and

a light intensity distribution measurement device which measures light intensity distribution of the visible light imaged by the optical image pickup system,

wherein an irradiated position is annealed, when the laser light is applied to the non-single crystal semiconductor thin film, and the light intensity distribution of the laser light is measured, when the laser light is applied to the light-emitting layer or the light-emitting region.

It is to be noted that the light intensity distribution measurement-device is, for example, a CCD. A photoelectric element which converts the light intensity into an electric signal is scanned in an image forming face of the optical image pickup system, and accordingly two-dimensional distribution of the light intensity of the emission can be measured.

According to the laser annealing apparatus, the light intensity distribution of the laser light can be adjusted in a short time. Therefore, the light intensity distribution of the laser light can be maintained constantly in a satisfactory state. According to the laser annealing apparatus of the present invention, since the light intensity distribution of the laser light can be correctly adjusted, a silicon crystal having a large grain diameter can be grown from the non-single crystal silicon thin film on the substrate.

A crystallization method according to the present invention using the above-described method is a crystallization method of applying laser light whose phase has been modulated to a substrate to be treated having a non-single crystal semiconductor thin film to form a crystallized region from the non-single crystal semiconductor thin film, the method comprising:

disposing a light-emitting layer which receives the laser light to emit visible light in a predetermined portion or the whole surface of the substrate to be treated; and

applying the laser light to the light-emitting layer before or after applying the laser light to the non-single crystal semiconductor thin film for crystallization, and picking up an image of the visible light emitted from the light-emitting layer to obtain light intensity distribution information of the laser light.

According to the semiconductor device of the present invention, the light intensity distribution of the laser light applied to the semiconductor device can be measured correctly in a short time. Furthermore, according to the method of measuring the light intensity distribution of the laser light of the present invention, the light intensity distribution of the laser light is changed into a light intensity distribution image by the visible light, the light intensity distribution image is picked up as a two-dimensional image, and a two-dimensional distribution shape can be obtained in the short time. Furthermore, it can be automatically judged whether or not the measured light intensity distribution is adapted to predetermined conditions.

Furthermore, according to the laser annealing apparatus of the present invention, the light intensity distribution of the laser light can be correctly measured, fluctuation of the light intensity distribution can be quickly detected, and laser annealing can be correctly on stable conditions. When the laser annealing is used in a crystallization process, the crystallized region having a stable grain diameter can be formed from the amorphous semiconductor thin film. When the laser annealing is used in an activation process, an activation process can be performed with respect to all activated regions on the same condition (light intensity distribution).

### BRIEF DESCRIPTION OF THE SEVERAL VIEWS OF THE DRAWING

FIG. 1A is a plan view showing an example of a substrate to be treated for laser annealing for use in a method of the present invention, and a light-emitting layer is formed on the whole surface of the substrate to be treated;

FIG. 1B is an A-B sectional view of FIG. 1A;

FIG. 2 is a sectional view showing another example of the substrate to be treated for the laser annealing for use in the method of the present invention, and the light-emitting layer is formed on the whole surface of the substrate to be treated;

FIG. 3A is a plan view showing an example of the substrate to be treated for the laser annealing for use in the method of the present invention, and the light-emitting layer is formed in a partial region of the substrate to be treated;

FIG. 3B is a C-D sectional view of FIG. 3A;

FIG. 4 is a sectional view showing another example of the substrate to be treated for the laser annealing for use in the method of the present invention, and the light-emitting layer is formed in the partial region of the substrate to be treated;

FIG. 5 is a sectional view showing still another example of the substrate to be treated for the laser annealing for use in the method of the present invention, and the light-emitting layer is formed in the partial region of the substrate to be treated;

FIG. 6 is a diagram showing an example of a system which images light intensity distribution of laser light using the method of the present invention;

FIG. 7 is a diagram showing an example of a laser annealing apparatus by a projection system, in which a system for imaging the light intensity distribution of the laser light using the method of the present invention is incorporated; and

FIGS. 8A to 8F are diagrams showing an example of a process of forming a thin film transistor in a crystallized region.

### DETAILED DESCRIPTION OF THE INVENTION

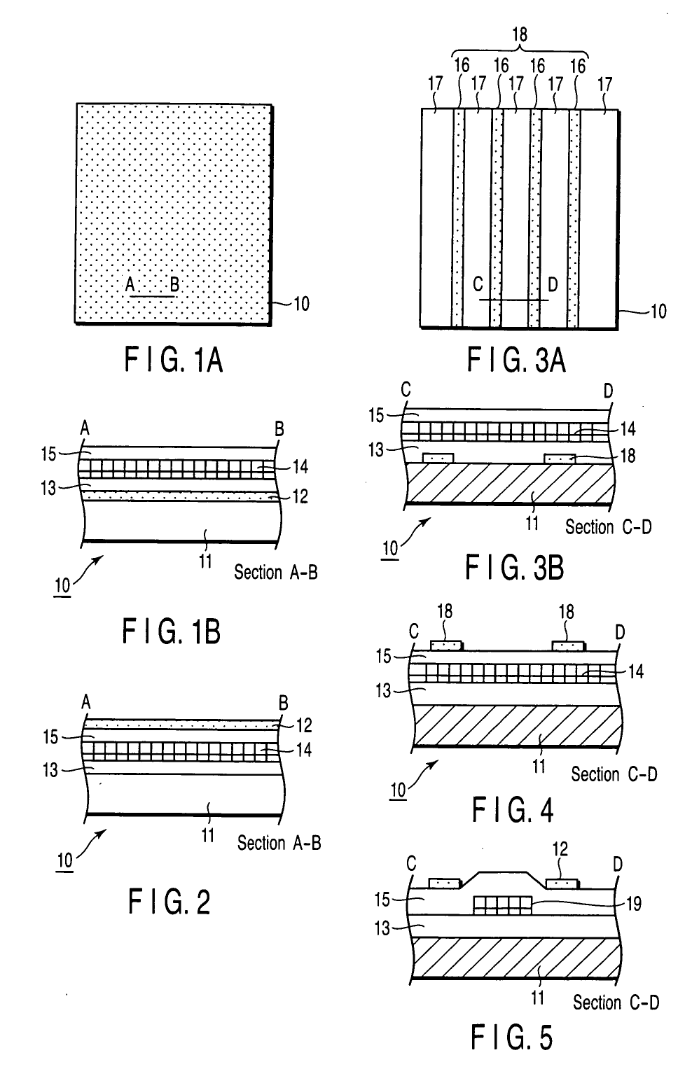

FIGS. 1 to 5 show various examples of a substrate to be treated, on which a light-emitting layer for measuring light intensity distribution of laser light is disposed. These light-emitting layers are used in measuring, imaging, or monitoring the light intensity distribution of the laser light, or in evaluating or adjusting a shape of the light intensity distribution.

### EXAMPLE 1

### A Substrate to be Treated, on Whose Whole Surface a Light-Emitting Layer is Formed

FIGS. 1A, 1B show an example of a substrate to be treated for laser annealing, having a non-single crystal semiconductor thin film and a light-emitting layer. In this example, the light intensity distribution can be imaged even in any position of the substrate to be treated.

FIG. 1A is a plan view of the substrate to be treated. In this example, a substrate 10 to be treated is a substrate for a liquid crystal display device, and has a square shape. A light-emitting layer 12 is formed on the whole flat face of the substrate 10 to be treated. FIG. 1B is a sectional view along line A-B of the substrate 10 to be treated of FIG. 1A. A substrate is a visible light transmitting substrate 11, for example, a general-purpose glass substrate. The light-emitting layer 12 which receives laser light to emit the light is formed (e.g., by coating) on the substrate 11. Furthermore, an underlayer insulating film 13 (e.g., SiO₂ layer) is formed on the light-emitting layer 12 in order to prevent permeation of glass of the substrate 11 or impurities from the light-emitting layer 12. The underlayer insulating film 13 is formed into a thickness of 100 nm, for example, by plasma CVD. An amorphous silicon layer 14 is formed as a non-single crystal semiconductor thin film on the underlayer insulating film 13. This amorphous silicon layer 14 is formed into a thickness of 20 to 200 nm, for example, by the plasma CVD.

A cap film 15 (e.g., SiO₂ layer) having a heat accumulating function is formed on the amorphous silicon layer 14 in order to a crystallized region having a large grain diameter. This cap film 15 is formed into a thickness of 50 to 500 nm, for example, by the plasma CVD. The substrate 10 to be treated for crystallization is constituted in this manner.

In this example, the light-emitting layer 12 is formed on a lower-layer side (glass substrate 11 side) of the amorphous silicon layer 14. The light-emitting layer 12 is used in measuring the light intensity distribution of the laser light, and is formed of a material which receives the laser light to emit the light. In this example, as to the light-emitting layer 12, a base material formed of SiO₂ contains about 2 wt. % of Eu as the light-emitting material. Additionally, there is also a method of containing nano-particles of CdSe and the like to obtain the emission, or a method of using films which absorb the laser light to emit the light, such as an SiOx film, SiON film, and Si₃N₄ film.

It is to be noted that as an example of a typical film thickness of the substrate 10 to be treated for crystallization, the thickness of the substrate 11 is about 0.7 mm, that of the underlayer insulating film 13 is about 1.0 μm, that of the amorphous silicon layer 14 is about 0.05 μm, and that of the light-emitting layer 12 is about 0.2 μm.

It is to be noted that to correctly measure the light intensity distribution of the laser light in a position of the face to be treated, from a viewpoint of emission intensity, the thickness of the light-emitting layer 12 is preferably 0.2 μm or more and 1.0 μm or less. The thickness of the amorphous silicon layer 14 is preferably 0.1 μm or less from a viewpoint of a transmission amount of the laser light which transmits through the amorphous silicon layer 14 to reach the light-emitting layer 12.

### EXAMPLE 2

### A Substrate to be Treated, on Whose Whole Surface a Light-Emitting Layer is Formed

FIG. 2 shows a sectional view of another example of a substrate to be treated for laser annealing, having a light-emitting layer. It is to be noted that a plan view is common to FIG. 1A described above. In the substrate to be treated shown in this example, the light-emitting layer is disposed on an upper-layer side of an amorphous semiconductor layer. The same part as that of FIG. 1B is denoted with the same reference numerals, and detailed description thereof is omitted.

FIG. 2 is a sectional view of the substrate to be treated of a portion corresponding to a line A-B in FIG. 1A. For example, an underlayer insulating film 13 (e.g., SiO₂ layer) is formed on a substrate 11 formed of a general-purpose glass. An amorphous silicon layer 14 is formed as a non-single crystal semiconductor thin film on the underlayer insulating film 13. A cap film 15 (e.g., SiO₂ layer) having a heat accumulating function is formed on the amorphous silicon layer 14. Furthermore, a light-emitting layer 12 is formed on the cap film 15. A substrate 10 to be treated is constituted in this manner. The substrate 10 to be treated of this example is characterized in that the light-emitting layer 12 is formed on an upper-layer side of the amorphous silicon layer 14.

The light-emitting layer 12 is used in measuring light intensity distribution of laser light, and is formed of a material which receives the laser light to emit light. In this example, as to the light-emitting layer 12, a liquid containing water-soluble pyranine is formed (e.g., by spin coating), for example, into a thickness of 1 μm. It is to be noted that this light-emitting layer 12 is coated, thereafter laser-annealed, and removed in a washing step.

As typical values in this case, thickness of the visible light transmitting substrate 11 is about 0.7 mm, that of the underlayer insulating film 13 is about 1.0 μm, that of the amorphous silicon layer 14 is about 0.05 μm, and that of the light-emitting layer 12 is about 0.2 μm. It is to be noted that to correctly measure the light intensity distribution of the laser light in a position of a face to be treated, the thickness of the light-emitting layer 12 is preferably ranging from 0.2 to 1.0 μm. The thickness of the amorphous silicon layer 14 is preferably 0.1 μm or less from a viewpoint of a decay amount at a time when the light emitted from the light-emitting layer 12 is transmitted through the amorphous silicon layer 14.

### EXAMPLE 3

### A Substrate to be Treated on Which a Light-Emitting Layer is Partially Formed

FIGS. 3A, 3B show an example of a substrate to be treated for laser annealing, on which a light-emitting layer is partially disposed. The same part as that of FIGS. 1A, 1B is denoted with the same reference numerals, and detailed description thereof is omitted. The light-emitting layer is disposed in a striped form on the substrate to be treated in this example. In this example, since an area for forming the light-emitting layer is small, a use amount of a light-emitting material may be small.

FIG. 3A is a plan view of the substrate to be treated. In a substrate 10 to be treated, light-emitting layer regions 16 are formed in a striped form, and non-light-emitting layer regions 17 are formed in other regions. A size of the light-emitting layer region 16 is determined in accordance with a size of an imaging face. For example, when the imaging face has a diameter of about 100 μmφ, the size of the light-emitting layer region 16 may be not less than a spot size of laser light, and an area of about 100×100 μm at minimum may be secured. Therefore, to arrange the light-emitting layer regions in the striped form, a width of each light-emitting layer region is preferably about 100 μm. The shape of the light-emitting layer region is not limited to a striped form, and any pattern may be used such as lattice, dot, L-shaped, cross, rectangular frame shapes. Furthermore, the positions of the light-emitting layer regions may be distributed on the whole substrate 11, may be arranged in a plurality of predetermined irregular positions, or may be disposed in one place.

FIG. 3B is a sectional view along line C-D of the substrate 10 to be treated of FIG. 3A. In this example, a striped light-emitting layer 18 is formed on a lower-layer side of a non-single crystal semiconductor thin film. The light-emitting layers 18 are formed into a striped shape on a visible light transmitting laser annealing. Furthermore, an underlayer insulating film 13 (e.g., SiO₂ layer) is formed on the light-emitting layer 18 and the substrate 11. An amorphous silicon layer 14 is formed as the non-single crystal semiconductor thin film on the underlayer insulating film 13. A cap film 15 (e.g., SiO₂ layer) having a heat accumulating function is formed on the amorphous silicon layer 14. The substrate 10 to be treated is constituted in this manner.

In this example, the striped light-emitting layer 18 is formed on the lower-layer side of the amorphous silicon layer 14. The light-emitting layer 18 is used in measuring or monitoring light intensity distribution of incident laser light (e.g., laser light for crystallization), and is constituted of a material which receives the laser light to emit light. In this example, as to the light-emitting layer 18, a base material formed of SiO₂ contains about 2 wt. % of Eu as a light-emitting material. Additionally, there is also a method of containing nano-particles of CdSe and the like to obtain the emission, or a method of using films which absorb the laser light to emit the light, such as a SiOx film, SiON film, and Si₃N₄ film.

It is to be noted that as typical examples in this case, thickness of the visible light transmitting substrate 11 is about 0.7 mm, that of the underlayer insulating film 13 is about 1.0 μm, that of the amorphous silicon layer 14 is about 0.05 μm, and that of the light-emitting layer 18 is about 0.2 μm. It is to be noted that to correctly measure the light intensity distribution of the laser light in a position of a face to be treated, the thickness of the light-emitting layer 18 is preferably 0.2 μm or more and 1.0 μm or less from a viewpoint of emission intensity. The thickness of the amorphous silicon layer 14 is preferably 0.1 μm or less from a viewpoint of a transmission amount of the laser light transmitted through the amorphous silicon layer 14 to reach the light-emitting layer 18.

### EXAMPLE 4

### A Substrate to be Treated on Which a Light-Emitting Layer is Partially Formed

FIG. 4 shows a sectional view of another example of a substrate to be treated for laser annealing, on which a light-emitting layer is partially disposed. It is to be noted that a plan view is common to FIG. 3A described above. In a substrate to be treated described in this example, a striped light-emitting layer is disposed on an upper-layer side of an amorphous semiconductor layer. The same part as that of FIG. 3B is denoted with the same reference numerals, and detailed description thereof is omitted.

FIG. 4 shows a sectional view of the substrate to be treated of a portion corresponding to a line C-D in FIG. 3A. An underlayer insulating film 13 (e.g., SiO₂ layer) is formed on a visible light transmitting substrate 11. An amorphous silicon layer 14 is formed as a non-single crystal semiconductor thin film on the underlayer insulating film 13. A cap layer 15 (e.g., SiO₂ layer) having a heat accumulating function is formed on the amorphous silicon layer 14. Furthermore, a striped light-emitting layer 18 is formed on the cap layer 15. A substrate 10 to be treated is constituted in this manner. The substrate 10 to be treated of this example is characterized in that the striped light-emitting layer 18 is formed on the upper-layer side of the amorphous silicon layer 14.

The light-emitting layer 18 is used in measuring or monitoring light intensity distribution of laser light, and is constituted of a material which receives the laser light to emit light. In this example, as to the striped light-emitting layer 18, a liquid containing water-soluble pyranine is spin-coated into a thickness of about 1 μm, and patterned. It is to be noted that this striped light-emitting layer 18 is removed in a washing step after laser annealing.

As typical values in this case, thickness of the visible light transmitting substrate 11 is about 0.7 mm, that of the underlayer insulating film 13 is about 1.0 μm, that of the amorphous silicon layer 14 is about 0.05 μm, and that of the light-emitting layer 18 is about 0.2 μm. It is to be noted that to correctly measure the light intensity distribution of the laser light in a position of a face to be treated, the thickness of the light-emitting layer 18 is preferably 0.2 μm or more and 1.0 μm or less from a viewpoint of emission intensity. The thickness of the amorphous silicon layer 14 is preferably 0.1 μm or less from a viewpoint of a decay amount at a time when light emitted from the light-emitting layer 18 passes through the amorphous silicon layer 14.

However, to avoid decay of light from the light-emitting layer 18 by the amorphous silicon layer 14, a sectional structure shown in FIG. 5 is considered. In this case, the amorphous semiconductor layer is patterned, so that an amorphous semiconductor layer 19 does not exist right under the striped light-emitting layer 18. In other words, amorphous semiconductor layers 19 may be arranged in a striped form between stripes of the light-emitting layer 18. When this structure is adopted, limitation on the film thickness of the amorphous silicon layer 19 is eliminated.

### EXAMPLE 5

### A Method of Measuring Light Intensity Distribution

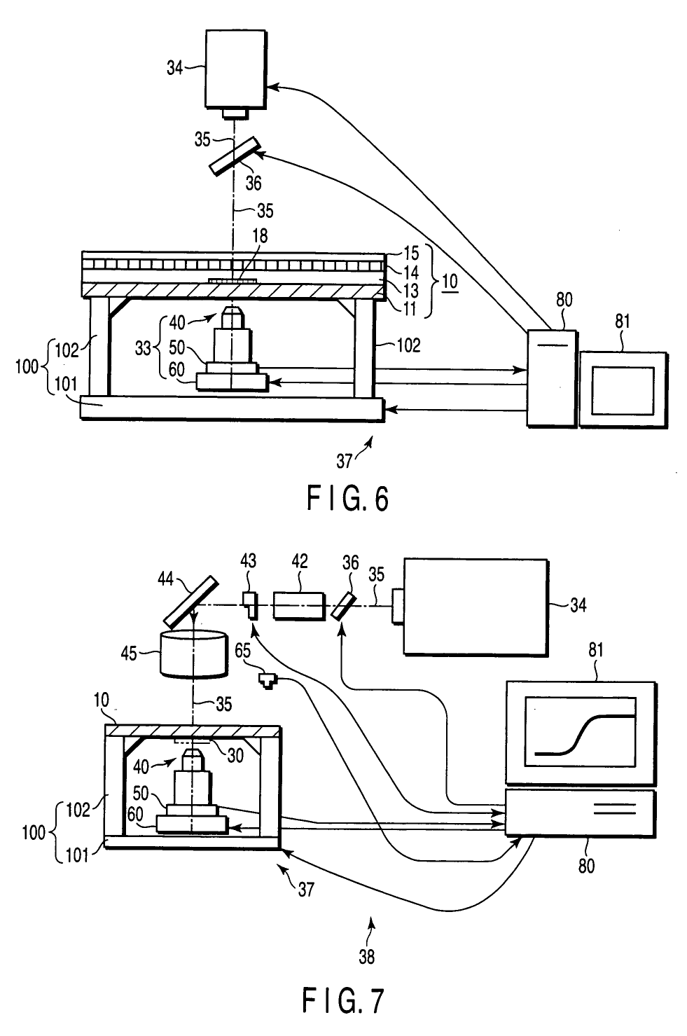

Next, an example of a method of measuring light intensity distribution of laser light based on the present invention will be described with reference to FIG. 6. FIG. 6 is a constitution diagram of a light intensity distribution measurement device for the laser light. In this example, a substrate 10 to be treated is similar to that described with reference to FIGS. 3A (plan view) and 3B (sectional view), and a light-emitting layer 18 which receives the laser light to emit visible light is disposed on a lower-layer side of an amorphous silicon layer 14. It is to be noted that the same part as that of FIGS. 3A, 3B is denoted with the same reference numerals, and detailed description thereof is omitted.

The substrate 10 to be treated having the light-emitting layer 18 is held on a sample stage 100 which is movable in X-axis, Y-axis, Z-axis, and θ-axis (rotation) directions. The sample stage 100 is a box member which is disposed on a base 101 and which is opened in an upper surface, and has a support frame 102 for supporting a peripheral edge portion of the substrate 10 to be treated. In this box member, an optical system 33 for measuring light intensity distribution of laser light, which has entered the substrate 10 to be treated, from the back surface of the substrate 10 to be treated is disposed. The back surface of the substrate 10 to be treated means a surface on a side opposite to a surface of the substrate 10 to be treated, which the laser light enters. A laser light source 34 is disposed on an optical axis of the optical system 33. An attenuator 36 for adjusting a laser light amount into a desired value is disposed in an optical path of laser light 35 emitted from the laser light source 34. For example, the laser light 35 emitted from the laser light source 34 vertically strikes on the surface of the substrate 10 to be treated, and irradiates the substrate 10 to be treated.

An image pickup device 50 is disposed coaxially with an extended line of the optical axis of the laser light 35 on the back surface (lower part of FIG. 6) of the substrate 10 to be treated via an optical image pickup system 40. The optical image pickup system 40 is constituted of an objective lens and an optical cylinder. The image pickup device 50 is attached to a focal position of the objective lens on a rear end of an optical cylinder 42. The image pickup device 50 comprises, for example, a CCD and the like.

The optical image pickup system 40 and the image pickup device 50 are held on an image pickup stage 60. The image pickup stage 60 is constituted in such a manner as to be adjustable in any of X-axis, Y-axis, Z-axis, and rotation (θ-axis) directions with respect to the base 101. The optical image pickup system 40 and the image pickup device 50 are positioned with respect to the optical axis of the laser light 35, when the image pickup stage 60 is moved in the X-axis and Y-axis directions. An objective lens 41 is focused by adjustment performed while moving the image pickup stage 60 in the Z-axis direction.

Basically, when adjustment is performed in such a manner as to match the laser light axis 35 with an optical axis of the optical image pickup system 40, there is not any movement of the image pickup stage 60 along the X-axis, Y-axis, and θ-axis. It is to be noted that when any image is not picked up, that is, when the amorphous silicon layer 14 is laser-annealed, a shutter 30 (see FIG. 7) is inserted between the substrate 10 to be treated and the optical image pickup system 40 in order to protect the optical system 33 for measuring the light intensity distribution. The substrate stage 100 and the image pickup stage 60 are constituted in such a manner as to be individually controllable, and the movement of the substrate stage 100 along X-axis, Y-axis, Z-axis, and θ-axis (rotation) does not interfere with that of the image pickup stage 60. Therefore, the Z-axis of the substrate stage 100 fluctuates, a focus of the light-emitting layer 12 shifts. Therefore, the image pickup stage 60 is controlled by a computer 80 in such a manner that the Z-axis of the image pickup stage 60 is also moved in accordance with the fluctuation of the Z-axis to thereby automatically adjust the focus.

An output circuit of the image pickup device 50 is connected to the computer 80. The computer 80 automatically controls the laser light source 34, attenuator 36, image pickup stage 60 and the like by a program for measuring the light intensity distribution of the laser light stored beforehand to thereby measure the light intensity distribution of the laser light.

After the focus of the optical image pickup system 40 is adjusted in accordance with the light-emitting layer 18 of the substrate 10 to be treated, an emission image of the light-emitting layer 18 by the incident laser light is picked up by the control of an oscillation timing of the laser light source 34, and the attenuator 36 by the computer 80. An output of light intensity distribution information of the incident laser light imaged by the image pickup device 50 is sent to the computer 80, and stored. The light intensity distribution information of the incident laser light, and data (i.e., measured light intensity distribution of the laser light) processed by the computer 80 is selectively displayed in a display device 81. In this manner, a light intensity distribution measurement device 37 of the laser light is constituted of: the optical system 33 for imaging the light intensity distribution of the laser light; the computer 80 which executes a control for automatically imaging the light intensity distribution of the laser light; and the display device 81 which displays the light intensity distribution of the laser light.

Next, a method of automatically imaging the light intensity distribution of the laser light by the light intensity distribution measurement device 37 for the laser light will be described.

To image the light intensity distribution of the laser light which has struck on the substrate 10 to be treated, the laser light 35 is applied toward the amorphous silicon layer 14 from the surface (upper part of FIG. 6) of the substrate 10 to be treated. The laser light 35 passes through the amorphous silicon layer 14 and underlayer insulating film 13, and enters the light-emitting layer 18 disposed in the striped shape, and the light-emitting layer 18 emits light. Here, when the intensity of the laser light 35 is suppressed to a certain degree or less as described above, it is possible to secure a linear relation between the intensity of the laser light which has entered the light-emitting layer 18, and that of the light emitted from the light-emitting layer 18. Therefore, when the intensity distribution of the visible light emitted from the light-emitting layer 18 is measured, the light intensity distribution of the laser light 35 can be imaged (measured) as a two-dimensional pattern. It is to be noted that in excimer laser, the laser light 35 itself is invisible light.

The visible light emitted from the light-emitting layer 18 enters the objective lens 41, and is two-dimensionally enlarged by the objective lens 41 to thereby reach the image pickup device 50. The image pickup device 50 converts an image into a digital signal, and sends the signal to the computer 80. It is to be noted that the laser light 35 (direct light) is substantially absorbed by the light-emitting layer 18, and is not transmitted. However, when there is a possibility of transmission, a filter for interrupting the laser light 35 may be inserted in the optical path. As to the filter, for example, a transparent glass substrate is coated with a multilayered coating film such as a dielectric.

In a typical case, a beam shape of the laser light 35 via which a sectional image is picked up has a size of about 100 μmφ in a 2 mm square of a laser irradiated region. This is two-dimensionally enlarged, for example, about 100 to 200 times by the objective lens, and projected as an image having a size of 10 to 20 mmφ on the image pickup device 50. Here, when a pixel size of the image pickup device 50 itself is set, for example, to 10 μm or less, a space resolution (i.e., space resolution with respect to a beam profile of the laser light) in the position of a face to be treated is theoretically ranging from 0.2 to 0.1 μm. However, since a wavelength of light emitted from the striped light-emitting layer 18 is about 0.5 μm, the space resolution is limited by the wavelength, and is about 0.5 μm.

### EXAMPLE 6

### Example of a Laser Annealing Apparatus

Next, an example of a laser annealing apparatus based on the present invention will be described with reference to FIG. 7. FIG. 7 is a constitution diagram of the laser annealing apparatus by a projection system, and a light intensity distribution measurement device 37 for laser light described above with reference to FIG. 6 is incorporated. The same part as that of FIG. 6 is denoted with the same reference numerals, and detailed description thereof is omitted.

In a laser annealing apparatus 38, an optical projection system is adopted in order to apply laser light to a substrate 10 to be treated. The substrate 10 to be treated for use in this example has, for example, a light-emitting layer 16 having a striped plane pattern as shown in FIG. 3A, and has a sectional structure shown in FIG. 3B.

A laser light source 34 is disposed in order to emit laser light having energy for annealing. Along an optical path of laser light 35 emitted from this laser light source 34, an attenuator 36, a homogenizer 42, a phase shifter 43, a mirror 44, a projection lens 45, the substrate 10 to be treated, and a light intensity distribution measurement device 37 for laser light are arranged in order in a travel direction of the laser light 35. A height of the substrate 10 to be treated is measured by a height sensor 65.

The pulse laser light 35 is emitted from the laser light source 34, adjusted (decayed) into an appropriate intensity required for laser annealing by the attenuator 36, and next enters the homogenizer 42 in which the light intensity distribution is homogenized. The phase shifter 43 is disposed in a position where the light intensity is homogenized, and phase of the pulse laser light 35 is modulated by the phase shifter 43. The laser light 35 whose phase has been modulated strikes on the mirror 44. The mirror 44 bends downwards the travel direction of the pulse laser light 35, and applies the light into the projection lens 45. The projection lens 45 reduces an image of the phase shifter 43, for example, at a magnification of ⅕, and the image is formed on the substrate 10 to be treated. Here, the phase shifter 43 disposed in the position where the light intensity is homogenized forms an image in a substrate surface position through the projection lens 45. This image has a conjugated relation with the phase shifter 43. When the substrate 10 to be treated is disposed in an image plane, the annealing is performed by the laser light whose phase has been modified. When the image of the laser light is picked up in the surface position of the substrate 10 to be treated, controllability of the laser annealing of the projection system can be enhanced.

It is to be noted that the phase shifter 43 is a light intensity modulation element which modulates the phase of the light to thereby form light intensity distribution adapted to a purpose of treatment of the substrate 10 to be treated on the surface of the substrate 10 to be treated. The phase shifter 43 is prepared, for example, by etching/forming a stepped position in a quartz substrate. In a crystallization process, the phase shifter 43 is formed into such a sectional shape that the phase of the laser light homogenized by the homogenizer 42 is modulated to obtain light intensity distribution having an inverse peak pattern. As described above, two-dimensional light intensity distribution is given to the pulse laser light 35 by the phase shifter 43, and an optical image is formed on the surface of the substrate 10 to be treated.

To pick up a sectional image of laser light for crystallization, which enters the surface of the substrate 10 to be treated, first a computer 80 moves a stage 100 in such a manner that a striped light-emitting layer 18 is positioned on an optical axis of the laser light 35. Next, the computer 80 operates the attenuator 36, and adjusts the intensity of the pulse laser light 35 into an intensity necessary for measuring predetermined light intensity distribution. That is, when the substrate 10 to be treated is irradiated with the pulse laser light 35, the pulse laser light 35 is decayed to such an extent that the laser light transmitted through the substrate 10 to be treated does not damage an image pickup device 50. Therefore, an incident light path of the image pickup device 50 needs to be completely interrupted by a shutter 30, or the image pickup device 50 needs to be retreated from the laser irradiated region in a laser annealing process period.

Next, the laser light 35 adjusted (decayed) into the appropriate light intensity in this manner is applied into the surface of the substrate 10 to be treated. The light intensity distribution measurement device 37 is incorporated in the back surface of the substrate 10 to be treated, and the light intensity distribution measurement device 37 images a two-dimensional pattern (emission pattern) of visible light emitted from the striped light-emitting layer 18. That is, the image pickup device 50 images the emission pattern, processes the image into emission pattern information, and outputs the information to the computer 80. The computer 80 associates this emission pattern information with a serial number of the substrate 10 to be treated, stores the information in a memory of the computer 80, and displays the information in a display device 81.

A series of process will be described further concretely. When the pulse laser light 35 is applied into the light-emitting layer 18 (FIG. 3B), an image of the emission pattern emitted from the light-emitting layer 18 is two-dimensionally picked up by an optical image pickup system 40 and image pickup device 50. The image pickup device 50 converts an image signal by the photographed emission pattern information into the digital signal, and sends the signal to the computer 80. The data (i.e., the measured light intensity distribution of the pulse laser light) processed by the computer 80 is displayed in the display device 81.

An operator displays and compares profile of the measured light intensity distribution with a target profile stored beforehand on the display device 81. When a difference between the both is within a predetermined allowable limit, the laser annealing of the substrate 10 to be treated is started. It is preferable for an operator to color and display the profile of the measured light intensity distribution displayed in the display device 81, and the target profile. This comparison process is defined as checking of the profile of the light intensity distribution.

When the difference between the both deviates from the allowable limit, the height and position of the phase shifter 43 (or the optical image pickup system 40) are adjusted in such a manner as to set the difference within the allowable limit. It is to be noted that the profile of the light intensity distribution may be automatically checked and adjusted using the computer 80.

The process for checking the profile of the light intensity distribution as described above can be performed by setting the number of substrates 10 to be treated, each having the light-emitting layer 18, and an appropriate interval of a process time. In the process for checking the profile of the light intensity distribution, for example, the followings are determined from an aspect of quality management: (a) the process is performed for each peripheral portion and middle portion on the plane of the substrate 10 to be treated; (b) the process is constantly performed in real time; (c) the process is performed at a process start time; and (d) the process is performed every time the light-emitting layer 18 is irradiated with the laser light.

When the amorphous silicon layer 14 of the substrate 10 to be treated having the light-emitting layer 18 is laser-annealed, as described above, the image pickup stage 60 is driven, the shutter 30 is inserted in an incident light path of the image pickup device 50, and the image pickup system is protected. In this state, an output of the pulse laser light 35 is raised to a predetermined energy amount necessary for the laser annealing, and the pulse laser light 35 is applied onto the amorphous silicon layer 14 (excluding a region in which the light-emitting layer 12 is inserted). The pulse laser light 35 enters the homogenizer 42, and accordingly the light intensity is homogenized. The pulse laser light 35 whose light intensity is homogenized is applied into the phase shifter 43, and the phase is modulated into the light intensity distribution having an inverse peak pattern.

The pulse laser light 35 having the inverse peak pattern light intensity distribution passes through a cap film 15 (SiO₂ layer) and enters the amorphous silicon layer 14. An irradiated region of the amorphous silicon layer 14 by the laser light 35 having the inverse peak pattern light intensity distribution efficiently absorbs the light, and is momentarily molten at high temperature. The cap film 15 and the underlayer insulating film 13 are set at the high temperature.

Thereafter, in an interruption period of the pulse laser light 35, the temperature of the molten region tends to rapidly drop, but the temperature slowly lowered by heat accumulated by the cap layer and underlayer insulating film. In this temperature drop process, a solid/liquid interface successively slowly moves in a transverse direction, and crystallization is performed. An irradiation period of the pulse laser light 35 for the crystallization is preferably set to a moment of about 200 nsec or less.

Since this crystallization step is performed by the movement to a predetermined position, a crystallized region can be broadly formed. The present inventors have found that unless the crystallization step is executed constantly on the same predetermined condition, the crystallized region having a uniform characteristic, size, and shape cannot be formed in the substrate 10 to be treated. This step of momentarily confirming the irradiation condition is possible in the present embodiment. When the step of confirming the irradiation condition can be performed momentarily, a uniform crystallized region can be formed on the whole surface, even if a size of the substrate 10 to be treated is a meter square. Furthermore, this step of momentarily confirming the irradiation condition needs to be appropriately performed, and a correct, secure, and highly reliable measurement method is required. This can be achieved in the present embodiment.

It is to be noted that a laser fluence value of excimer laser light in melting and crystallizing the amorphous silicon layer 14 is, for example, 400 mJ/cm². On the other hand, the laser fluence in imaging the light intensity distribution of the excimer laser light is, for example, about from 10 mJ/cm² to 30 mJ/cm².

As the region crystallized in this manner, a region having a size capable of forming one or several thin film transistors is obtained. When one or several thin film transistors can be formed in the crystallized region, a transistor circuit can be formed.

### EXAMPLE 7

### Example of a Process for Forming a Thin Film Transistor

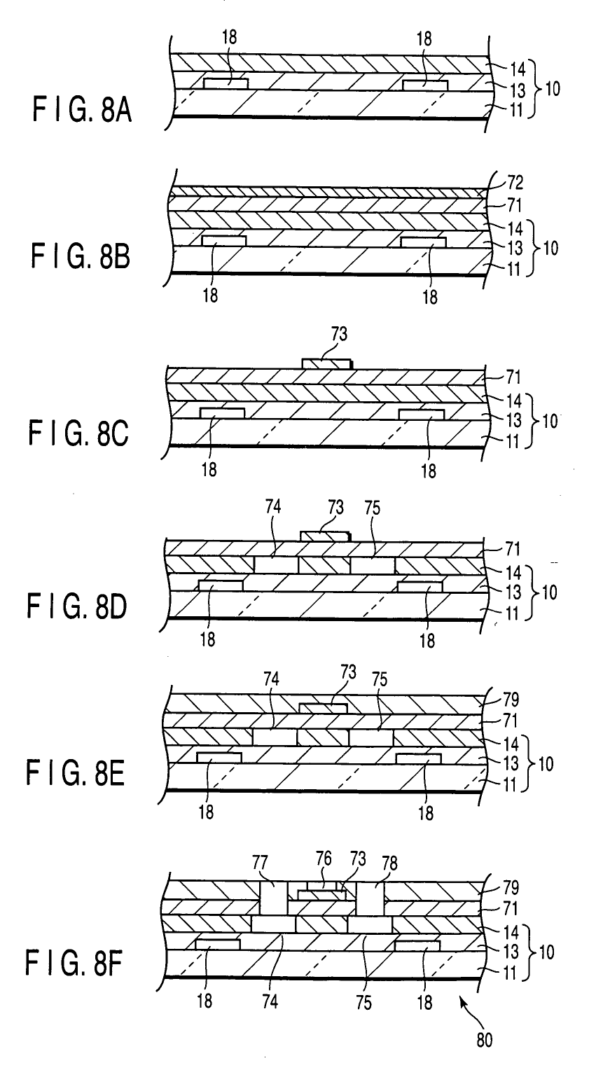

Next, an example of a process for forming a thin film transistor in a crystallized region will be described with reference to FIGS. 8A to 8F. In the process of this example, the thin film transistor is formed from a substrate 10 to be treated described above with reference to FIG. 3B, that is, the substrate 10 to be treated, in which a striped light-emitting layer 18 is formed on a lower-layer side of an amorphous silicon layer 14. The same part as that of FIG. 3B is denoted with the same reference numerals, and detailed description thereof is omitted.

It is to be noted that even in a case where the crystallization is performed using any of the substrates 10 to be treated, described above with reference to FIGS. 1 to 5, a semiconductor device in which a thin film transistor circuit is formed can be manufactured in a similar process.

FIG. 8A is a sectional view showing a structure of the substrate 10 to be treated, shown in FIG. 3B, which has been crystallized by a laser annealing apparatus 38 of FIG. 7. A crystallization process is completed, and a cap film 15 (SiO₂ layer) disposed on an amorphous silicon layer 14 in which the crystallized region has been formed is etched/removed. To form a gate insulating film on the exposed amorphous silicon layer 14, for example, a silicon oxynitride film 71 having a thickness-of 30 to 120 nm is formed using a material mainly composed of silicon oxide (SiO₂) or silicon oxynitride (SiON). For example, the silicon oxynitride film 71 is formed into a thickness of 50 nm by a silicon oxynitride film containing SiH₄ and N₂O as raw materials by a plasma CVD process.

Next, a conductive layer 72 is formed in order to form a gate electrode on the silicon oxynitride film 71 (FIG. 8B). This conductive layer 72 can be formed using a material mainly composed of elements such as Ta, Ti, W, Mo, and Al and a known deposition process such as a sputtering process and a vacuum deposition process. For example, the conductive layer 72 of an Al—Ti alloy is patterned using a gate electrode mask by photolithography, and a gate electrode 73 having predetermined pattern is formed (FIG. 8C).

Next, when impurities are ion-implanted using the gate electrode 73 in a mask, a source region 74 and a drain region 75 are formed (FIG. 8D). For example, when a P-channel type TFT is formed, P-type impurities such as boron ions are implanted using an ion injection process. Boron concentrations of these regions 74, 75 are set to, for example, 1.5×10²⁰ to 3×10²¹. In this manner, a high-concentration p-type impurity region constituting the source region 74 and the drain region 75 of the P-channel type TFT is formed. At this time, when n-type impurities are implanted, an n-channel-type TFT is formed. When p-type impurities are implanted, p-channel-type TFT is formed.

Next, to activate the ion-implanted impurity elements, an energy value of the laser light 35 is adjusted into a predetermined light intensity using the laser annealing apparatus shown in FIG. 7, a thermal treatment step is performed by a laser annealing process. This thermal treatment step can be performed by such as processes such as a furnace annealing process and a rapid thermal annealing process in addition to the laser annealing process. In this example, since the thermal treatment step is performed by the laser annealing process using the pulse laser light, a substantially low temperature treatment is performed, and general-purpose glass or plastic is usable in the substrate 11.

Next, an interlayer insulating film 79 is formed on the silicon oxynitride film 71 including the gate electrode 73 (FIG. 8E). This interlayer insulating film 79 may be formed of a stacked film obtained, for example, by a silicon nitride film, a silicon oxide film, a silicon oxynitride film, or a combination of them. A film thickness of the interlayer insulating film 79 may range from 200 to 600 nm, for example, 400 nm.

Next, contact holes 76 to 78 are made in predetermined positions of the interlayer insulating film 79, for example, in the gate electrode 73, source region 74, and drain region 75 (FIG. 8F). Moreover, conductive layers are formed inside the respective contact holes 76 to 78 and on the surface of the interlayer insulating film 79, and patterned into predetermined shapes to thereby form wirings. In this example, a source/drain electrode was formed into a three-layer structure stacked film in which 100 nm of a Ti film, 300 nm of an aluminum film containing Ti, and 150 nm of a Ti film were continuously stacked by a sputtering process. In this manner, a thin film transistor circuit 80 is manufactured.

What is claimed is:

1. A semiconductor device comprising:
a visible light transmitting substrate;
a non-single crystal semiconductor thin film formed on the substrate; and
a light-emitting layer or a light-emitting region which is disposed on or in the substrate and which receives laser light to emit visible light.

2. The semiconductor device according to claim 1, wherein the light-emitting layer or the light-emitting region is disposed in at least one layer excluding the non-single crystal semiconductor thin film among a plurality of thin film layers formed on the substrate.

3. The semiconductor device according to claim 2, wherein the light-emitting layer or the light-emitting region has a thickness of 1 μm or less.

4. The semiconductor device according to claim 2, wherein the light-emitting layer or the light-emitting region has a thickness of 0.5 μm or less.

5. The semiconductor device according to claim 1, wherein, of the visible light emitted from the light-emitting layer or the light-emitting region, the highest peak in light intensity distribution with respect to wavelength exhibits a half-value breadth of 0.05 μm or less.

6. A method of measuring light intensity distribution in a plane of a non-single crystal semiconductor thin film formed on a substrate, the method comprising:
disposing a light-emitting layer or a light-emitting region which receives laser light to emit visible light on or in the substrate;
applying the laser light toward the light-emitting layer or the light-emitting region;
imaging the light intensity distribution of the visible light emitted from the light-emitting layer or the light-emitting region from the back surface of the substrate using an optical image pickup system; and
obtaining the light intensity distribution of the laser light in the plane from the light intensity distribution of the visible light obtained in this manner.

7. A laser annealing apparatus which applies laser light to a substrate to be treated having a non-single crystal semiconductor thin film and which grows crystal grains from the non-single crystal semiconductor thin film, the substrate to be treated having a light-emitting layer or a light-emitting region which receives the laser light to emit visible light, the laser annealing apparatus comprising:
a laser light source which emits the laser light toward the substrate to be treated;
an optical image pickup system disposed on the back surface of the substrate to be treated; and
a light intensity distribution measurement device which measures light intensity distribution of the visible light imaged by the optical image pickup system,
wherein an irradiated position is annealed, when the laser light is applied to the non-single crystal semiconductor thin film, and the light intensity distribution of the laser light is measured, when the laser light is applied to the light-emitting layer or the light-emitting region.

8. A crystallization method of applying laser light whose phase has been modulated to a substrate to be treated having a non-single crystal semiconductor thin film to form a crystallized region from the non-single crystal semiconductor thin film, the method comprising:
disposing a light-emitting layer which receives the laser light to emit visible light in a predetermined portion or the whole surface of the substrate to be treated; and
applying the laser light to the light-emitting layer before or after applying the laser light to the non-single crystal semiconductor thin film for crystallization, and picking up an image of the visible light emitted from the light-emitting layer to obtain light intensity distribution information of the laser light.
